(19) United States
(12) Patent Application Publication
(10) Pub. No.: US 2017/0259507 A1
(43) Pub. Date: Sep. 14, 2017

(54) ADDITIVE MANUFACTURING PROCESS AUTOMATION SYSTEMS AND METHODS

(71) Applicant: SABIC GLOBAL TECHNOLOGIES B.V., Bergen op Zoom (NL)

(72) Inventor: Thomas Hocker, Pittsfield, MA (US)

(21) Appl. No.: 15/531,854

(22) PCT Filed: Dec. 1, 2015
(86) PCT No.: PCT/IB2015/059255

§ 371 Date: May 31, 2017

Related U.S. Application Data
(60) Provisional application No. 62/085,833, filed on Dec. 1, 2014.

(51) Int. Cl. B29C 67/00; B33Y 30/00; B33Y 40/00; B33Y 10/00

(52) U.S. Cl. CPC B29C 67/0085; B29C 67/0055; B33Y 10/00; B33Y 30/00; B33Y 40/00

(57) ABSTRACT

An automated additive manufacturing system can optionally include a conveyable build sheet (185). A part removal device (211) can be positioned in proximity to a surface of the build sheet to facilitate separating a part composite (281) from the build sheet. The build sheet can optionally include a turn or fold at which a part composite can be detached from the build sheet. A conveyor including a part composite can be moved through a solvent area having a solvent that is configured to dissolve or separate a support material from a model material in a part composite. A sorting device can be configured to identify characteristics of different part composites, and in response, direct selected ones of the parts to different receiving areas in the system. The system can include a drying device to dry a part composite using an airflow.

### CLAIM OF PRIORITY

This application claims the benefit of priority under 35 U.S.C. §119(e) to U.S. Provisional Patent Application Ser. No. 62/085,833, entitled “ADDITIVE MANUFACTURING PROCESS AUTOMATION SYSTEMS AND METHODS”, filed on Dec. 1, 2014, which is herein incorporated by reference in its entirety.

### BACKGROUND

Additive manufacturing, or three-dimensional (3D) printing, is a production technology for using an automated system to make a solid object based on a digital model. Generally, computer-aided design (CAD) modeling software is used to create the digital model of a desired solid object. Instructions for an additive manufacturing system are then created based on the digital model, for example by virtually “slicing” the digital model into cross-sections or layers. The layers can be formed or deposited in a sequential process in an additive manufacturing device to create the object.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example of an additive manufacturing system and a control circuit.

FIGS. 2A-2D illustrate generally examples of tools or systems that can be used to separate a part composite from a build sheet.

FIGS. 3A-3F illustrate generally examples of multiple part removal devices.

FIG. 4 illustrates generally an example of a method for using a part removal device.

FIG. 5 illustrates generally an example of a portion of a system that can be used to separate a part composite from a conveyor surface sheet using a turn.

FIG. 6 illustrates generally an example of a method for separating a part composite from a conveyor surface using a turn in the conveyor.

FIGS. 7A and 7B illustrate generally examples of systems that can be used to apply an agent to a part composite.

FIGS. 8A, 8B, and 8C illustrate generally examples of dividers for use with a conveyor.

FIG. 9 illustrates generally an example of a method for applying an agent to a part composite.

FIGS. 10A, 10B, and 10C illustrate generally examples of systems having sorting stations that can be used to sort or relocate one or more part composites in an assembly line.

FIG. 11 illustrates generally an example of a method that includes directing a flow for a part composite based on an identified characteristic of the part composite.

FIG. 12 illustrates generally an example of a drying station.

### DETAILED DESCRIPTION

This detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of the elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the claims, the terms “including” and “comprising” are open-ended, that is, a system, device, article, composition, formulation, or process that includes elements in addition to those listed after such a term in a claim are still deemed to fall within the scope of that claim. Moreover, in the claims, and in this detailed description, the terms “first,” “second,” and “third,” etc. are generally used merely as labels, and are not intended to impose numerical requirements on their objects.

Systems, devices, and methods according to the present disclosure are configured primarily for use in additive manufacturing (AM), also referred to as material extrusion additive manufacturing, deposition modeling, or three-dimensional (3D) printing. Without limiting the scope of the present disclosure, systems for additive manufacturing can include stand-alone manufacturing or printing units, a series of units on an assembly line, or a high volume system for additive manufacturing that includes one or more workflow automation features such as a conveyor for transporting parts to or from a build area, or a robot (e.g., a robotic arm) for transporting parts or adjusting a system component.

Polymeric materials can be used in the additive manufacturing systems described herein. Polymeric materials can include high-performance engineering thermoplastic polymers such as polycarbonate-based polymers (PC), polymethyl methacrylate polymers (PMMA), polyethylene terephthalate polymers (PET), polybutylene terephthalate polymers (PBT), styrene polymers, polyetherimide (PEI), acrylic-styrene-acrylonitrile polymers (ASA), and acrylonitrile-butadiene-styrene polymers (ABS), among others. The polymeric materials can include blends of these polymers together or with other polymers: for example a blend of polycarbonate and acrylonitrile-butadiene-styrene (PC/ABS), commercially available under the trade name CYCOLOY from the Innovative Plastics division of SABIC; a blend of polyphenylene ether (PPE) with other polymers, such as polystyrene, as in the blend of PPE and high-impact polystyrene (HIPS) commercially available under the trade name NORYL from the Innovative Plastics division of SABIC, or with polyamide, as in the PPE/polyamide blend available under the trade name NORYL GTX from the Innovative Plastics division of SABIC, or with polypropylene (PP), as in the PPE/PP blend commercially available under the trade name NORYL PPX from the Innovative Plastics division of SABIC. The polymeric materials can include copolymers of these polymeric base materials together or with other polymers, such as a block copolymer of PEI and siloxane, for example the amorphous block copolymer of PEI and siloxane soft-blocks commercially available under the trade name SILTEM from the Innovative Plastics division of SABIC. Polymeric and other materials, such as those suitable for use with the additive manufacturing systems and methods of the present disclosure, are discussed at length below.

Additive manufacturing systems can include, among others, systems configured to perform fused deposition modeling, or fused deposition modeling (FDM). FDM is an additive process in which layers of material are successively deposited and fused together to form a part composite. Materials suitable for FDM include production-grade thermoplastics such as ABS, ASA, PC, PEI, ULTEM, PET, or PBT, polyimide (e.g., EXTEM), among others. Support material used in FDM can optionally be water based.

Some examples of additive manufacturing systems include Polyjet, Selective Laser Sintering, Multijet Modeling, and Stereolithography systems. Polyjet is an additive process that uses a UV-cured photopolymer resin that can be deposited using a print head. In Selective Laser Sintering, or SLS, powdered metal or ceramic materials can be deposited and cured, such as using a laser to melt a surface of a powered material. Some materials suitable for SLS processes include nylon, titanium, and brass. In Multijet Modeling, or MJM, a microscopic layer of resin is deposited on a support made of wax, and the wax can be melted away from the part composite. In Stereolithography, a laser can be used to cure a deposited resin material. These additive manufacturing systems and others can be improved or made more efficient by employing the systems and methods described herein.

The present inventor has recognized that one way to improve throughput, efficiency, or economics in an additive manufacturing system includes facilitating or expediting part composite processing after a build event, or after a portion of a build event. An additive manufacturing system includes a build area with an extrusion head assembly configured to deposit material on a build surface. The build surface can optionally include a portion of a movable conveyor belt. A part composite can be built using the extrusion head assembly to dispense material directly on to the build surface portion of the conveyor belt. Systems, devices, and methods described herein can help to facilitate or expedite part composite processing by aiding in removal of a part composite from a build surface, such as a build surface comprising a portion of a conveyor belt. And as explained further below, one or more of a knife edge, a belt turn, a belt twist, or a belt surface change can be used, among other systems or techniques.

Systems, devices, and methods described herein can help to facilitate or expedite part composite processing by separating a model material from a support material, or by cleaning or rinsing a part composite. A liquid or gas, such as including water, cleanser, solvent or an anti-solvent configured to dissolve or remove a support material or flush solvent, can be provided to process the part composite. A conveyor-based system can be used to transport a part composite through a bath area or through multiple bath areas arranged in series. A bath area can include, among other things, a liquid pool or reservoir that is configured to retain a liquid, or a nozzle dispenser for releasing a liquid or gas toward a part composite.

Systems, devices, and methods described herein can help to facilitate or expedite part composite processing by sorting parts that are arranged on an assembly line. A robotic arm, piston, vacuum, conveyor, nozzle (e.g., for dispensing liquid or gas), or other device can be provided to relocate one or more part composites from a first area to a second, downstream processing area. For example, a conveyable build sheet can include multiple, serially-arranged part composites. As the build sheet is conveyed away from the build area, a robotic arm can selectively acquire, relocate, and release a specified part composite, such as using machine vision to distinguish between one or more characteristics or features that are unique to different part composites.

Systems, devices, and methods described herein can help to facilitate or expedite part composite processing by providing a part composite dryer. The dryer can include one or more of a nozzle, cloth, tumbler, or other device configured to dry a part composite or to remove liquid residue from a part composite. The dryer can be positioned near or around (e.g., encircling) a portion of a conveyor belt such that a part composite on the conveyor belt can be moved through an active drying area of the dryer. A part composite can be weighed or visually inspected to determine when the part is sufficiently dry, or the dryer can operate for a specified duration to achieve a specified dryness.

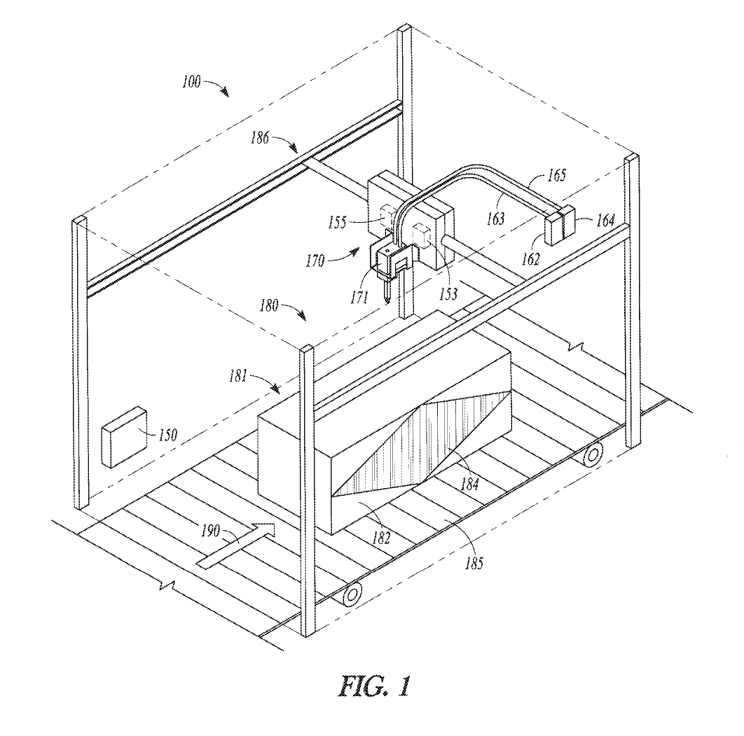

Various additive manufacturing systems can be used with the systems, devices, and methods described above for facilitating or expediting part composite processing. For example, FIG. 1 illustrates generally an example of a portion of an additive manufacturing system 100 that can be used. The system 100 includes a build area 180, a movable extrusion head assembly 170, and a system control circuit 150. The extrusion head assembly 170 is movable within the build area 180 in response to instructions from the system control circuit 150. The system control circuit 150 can include, among other things, a processor circuit or information gateway that can provide instructions to the extrusion head assembly 170, or to other portions of the system 100, and the instructions can be interpreted and used by portions of the system 100 to create or process a part composite 181. The part composite 181 can include one or more of a support material 182 and a model material 184.

The extrusion head assembly 170 can include, or can be configured to be coupled to, one or more nozzle cartridges. A nozzle cartridge generally includes a raw material input, a liquefier for heating successive portions of raw material, and a nozzle tip for dispensing the heated material. In some examples, the nozzle cartridge is configured to receive a polymer filament at the raw material input. A nozzle cartridge can be configured to dispense multiple different types of materials, or a nozzle cartridge can be configured to dispense a specified single material. A nozzle cartridge can include a nozzle tip that is configured for dispensing a specified material, or range of materials, at a specified material dispensing rate.

The extrusion head assembly 170 can optionally include a liquefier assembly 155, a temperature control device 153, or a drive assembly. The liquefier assembly 155 can be used to liquefy a material supplied (e.g., in filament form) to the extrusion head assembly 170 from a material source. The temperature control device 153 can optionally be used to heat the liquefier assembly 155, or to heat a portion of a nozzle cartridge that is installed in a chassis of the extrusion head assembly 170.

The build area 180 can include, among other features, a conveyable build sheet 185 and an x-y gantry 186. The conveyable build sheet 185 includes a portion upon which the part composite 181 can be formed. The conveyable build sheet 185 can optionally be movable along a vertical z-axis, such as in response to instructions received from the system control circuit 150, such as by adjusting a vertical position of one or more rollers upon which the belt moves. The x-y gantry 186 can include a guide rail system that is configured to move the extrusion head assembly 170 in a horizontal x-y plane within the build area 180. In some examples, the x-y gantry 186 or the extrusion head assembly 170 can be additionally movable in the vertical z-axis. In some examples, the conveyable build sheet 185 can be movable in the horizontal x-y plane within the build area 180, and the extrusion head assembly 170 can be movable along the vertical z-axis. Other arrangements can additionally or alternatively be used such that one or both of the conveyable build sheet 185 and the extrusion head assembly 170 is moveable relative to the other.

The extrusion head assembly 170 is supported by the x-y gantry 186 in the example of FIG. 1, and the extrusion head assembly 170 is movable in the horizontal x-y plane to create the part composite 181 in a layer-by-layer manner using one or more of the model material 184 and the support material 182.

In the example of FIG. 1, the first nozzle cartridge 171 can be configured to receive multiple filament materials. A support material filament can be routed from a support material source 162, optionally using a first filament conduit 163, to the first nozzle cartridge 171. A model or part material filament can be routed from a model material source 164, optionally using a second filament conduit 165, to the first nozzle cartridge 171. The material sources can include respective spools of filament polymer (and/or support material) that can be driven or drawn through the respective filament conduits to a specified nozzle cartridge in the system 100.

The support and model materials 182 and 184 can be provided to system 100 in various media or configurations. For example, the materials can be supplied in the form of a continuous filament, such as on a spool in a filament cassette. A filament, such as having a circular cross section, can have any one or more of various diameters, such as ranging from about 1 millimeter or less to about 3 millimeters or more. At least one of the material sources can include a raw material in some form other than a filament, such as in pellet form. A conduit suitable for transporting one or more of a solid pellet or a flowable polymer can be used to exchange the raw material between a source and a nozzle cartridge.

Support or model material 182 or 184 can be deposited onto the conveyable build sheet 185 to create the part composite 181. As referred to herein, a part composite can include one or both of the support material 182 and the model material 184. Generally, support material 182 is deposited to provide vertical support along the z-axis, such as for overhanging portions or layers of the model material 184. After a layer is deposited, or a build operation is complete, the resulting part composite 181 can be removed from the build area 180, such as manually by an operator, automatically using the conveyable build sheet 185, automatically using a robotic arm, or using some other device to relocate the part composite 181. The support material 182 can be separated from the model material 184 before or after the part composite is removed from the build area 180. In some examples, the support material 182 can be automatically removed, dissolved, or otherwise detached from the model material 184.

In the example of FIG. 1, the part composite 181 can be conveyed downstream 190, such as using the conveyable build sheet 185, to another portion of the additive manufacturing system 100 where the part composite 181 can receive other processing. The conveyable build sheet 185 can be conveyed at multiple different speeds. The speed can be adjusted based on a characteristic of a part composite on the sheet, or based on a process to be applied to the part composite on the sheet. The other processing includes automatically separating the part composite 181 from the conveyable build sheet 185, washing, rinsing, smoothing, painting, or otherwise spraying the part composite 181, or drying the part composite 181. For example, smoothing a part composite can include solvent vapor honing of the part composite, or tumbling the part composite in smoothing media, among other techniques.

The control circuit 150 can include a processor circuit or a software module (e.g., code embodied (1) on a non-transitory machine-readable medium or (2) in a transmission signal) or a hardware-implemented module. A hardware-implemented module can include a tangible unit capable of performing various, programmable operations. In some examples, one or more computer systems (e.g., including a standalone, target or server computer system) or one or more processor circuits may be configured by software (e.g., an application or application portion) as a hardware-implemented module that operates to perform operations as described herein.

In some examples, the hardware-implemented module can be implemented mechanically or electronically. For example, the hardware-implemented module can include dedicated circuitry or logic that is permanently configured, for example, as a special-purpose processor circuit, such as a field programmable gate array (FPGA) or an application-specific integrated circuit (ASIC), to perform specified operations. The hardware-implemented module can include programmable logic or circuitry (e.g., as encompassed within a general-purpose processor or other programmable processor) that can be temporarily configured by software to perform certain operations. The decision to implement a hardware-implemented module mechanically, in dedicated and permanently configured circuitry, or in temporarily configured circuitry (e.g., configured by software) may be driven by cost and time considerations.

The various operations and methods described herein may be performed, at least partially, by one or more control or processor circuits that are temporarily configured (e.g., by software) or permanently configured to perform the relevant operations. Whether temporarily or permanently configured, such processor circuits may constitute processor-implemented modules that operate to perform one or more operations or functions. The performance of certain ones of the operations described herein can optionally be distributed among two or more processors or control circuits, not only residing within a single machine, but deployed across a number of machines, such as including in different portions of an additive manufacturing system. For example, although referred to generally herein as a control circuit 150, the circuit can include a module at or near the build area 180 to provide feedback or instructions to the extrusion head assembly 170 about a built event status, and the circuit can include a module in a post-processing or other downstream area of the system.

In additive manufacturing, a built part composite can adhere or stick to the build surface or substrate after the build event. The part composite may need to be separated from the substrate, such as using one or more of physical force, a solvent, or other means. The part composite 181 is built on a portion of the surface of the conveyable build sheet 185. Depending on the geometry of the part, and the surface area of the portion of the part composite 181 that contacts the conveyable build sheet 185, the part composite 181 may be adhered to the conveyable build sheet 185. The part composite 181 can be separated, dislodged, or otherwise removed from the surface of the conveyable build sheet 185 using an automated tool.

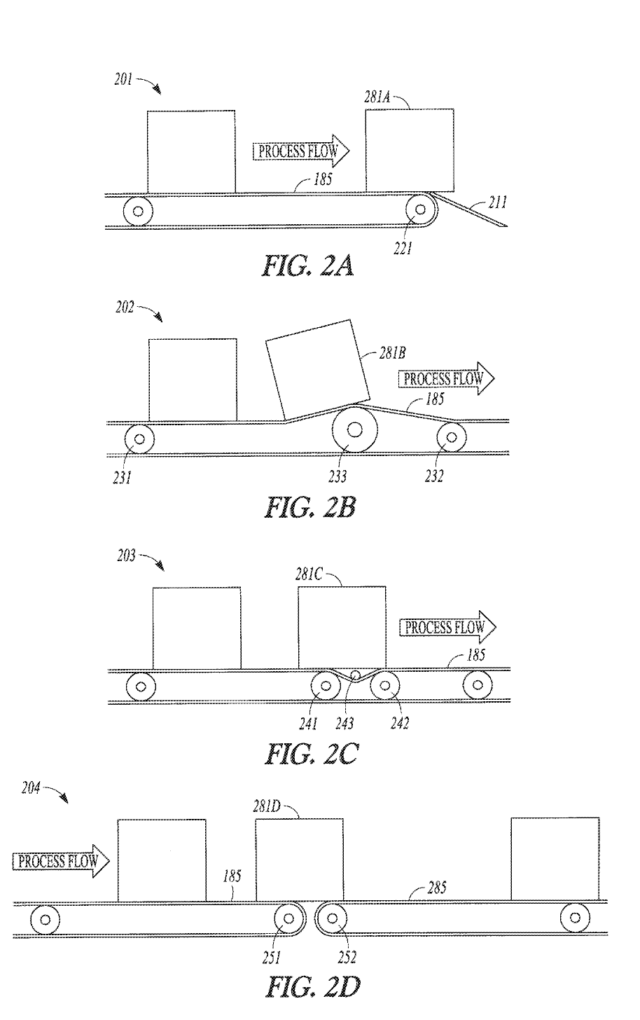

FIGS. 2A, 2B, 2C, and 2D illustrate generally examples of tools or systems that can be used to separate, or to facilitate separation of, a part composite from a movable or conveyable build sheet 185. In an example 201 of FIG. 2A, the conveyable build sheet 185 can move a first part composite 281A in a process flow direction. The conveyable build sheet 185 can end or change direction at a first roller 221. In some examples, the first part composite 281A can fall off of the surface of the conveyable build sheet 185 as the sheet changes direction at the first roller 221. If, however, the first part composite 281A is adhered or attached to the conveyable build sheet 185, then the first part composite 281A can potentially be damaged as the conveyable build sheet 185 changes direction under a portion of the part. In other examples, a portion of the first part composite 281A can maintain some attachment to the conveyable build sheet 185 as the sheet changes direction. If a portion remains attached to the conveyable build sheet 185, then other obstacles or process issues can be encountered by the attached portion over the travel of the conveyable build sheet 185, such as if the sheet loops back to the build area of the additive manufacturing system.

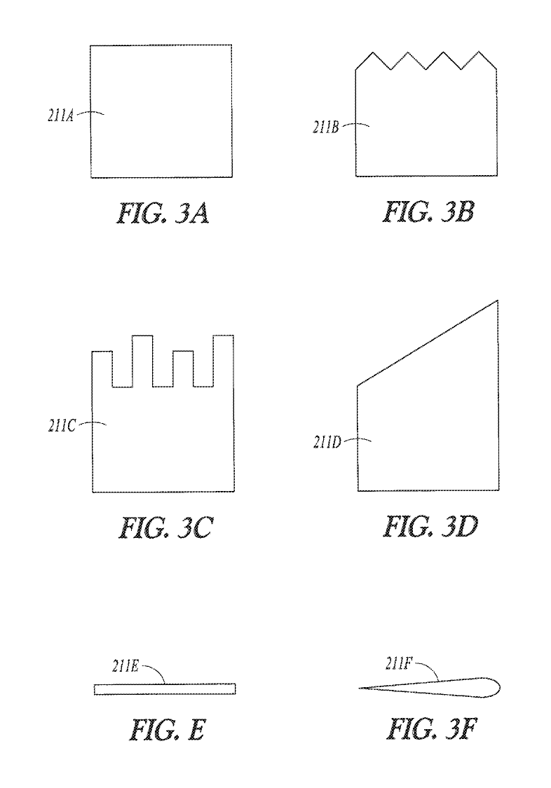

A first part removal device 211 or tool can be positioned near or coincident with an end of the conveyable build sheet 185 to separate, or the facilitate separation of, the first part composite 281A from the conveyable build sheet 185. In the example of FIG. 2A, the first part removal device 211 includes an edge portion that is positioned to contact one or both of a surface of the conveyable build sheet 185 and a part composite on the conveyable build sheet 185. The edge portion of the first part removal device 211 can include a wedge, knife-edge, or other tapered or blunted edge that is configured to impinge on the part or on the conveyable build sheet 185. In the example 201 of FIG. 2A, the edge portion of the first part removal device 211 is positioned in-line with the top or build surface of the conveyable build sheet 185 such that the first part removal device 211 can impinge on a corner or edge portion of the first part composite 281A as the first part composite 281A moves over the first roller 221. The edge portion can include multiple teeth or extensions, as further described below in the examples of FIGS. 3B and 3C.

An orientation or position of the first part removal device 211 can be adjusted relative to the conveyable build sheet 185, the first roller 221, or the first part composite 281A. The orientation of the first part removal device 211 can be updated or adjusted, such as automatically using one or more actuators or motors, for each of several different part composites arranged on the conveyable build sheet 185. A distance between the edge portion of the first part removal device 211 and the surface of the conveyable build sheet 185 can be adjustable, and can be changed, for example, based on one or more characteristics (e.g., shape, mass, orientation, etc.) of the first part composite 281A. An angle of the first part removal device 211 can be adjusted relative to the surface of the conveyable build sheet 185 and the first roller 221. An offset or distance between the first part removal device 211 and the surface of the conveyable build sheet 185 can be adjusted. In the example of FIG. 2A, a top surface of the first part removal device is shown having a downward slope relative to the surface of the conveyable build sheet 185. The top surface of the first part removal device 211 can be angled upward, opposite from the direction shown in the example of FIG. 2A, and the first part removal device 211 can be positioned above the surface of the conveyable build sheet 185, such as by a specified or adjustable distance.

Referring now to FIGS. 3A-3F, several examples 211A-211D illustrate generally several configurations of the first part removal device 211. FIGS. 3A-3D illustrate top views, and FIGS. 3E and 3F illustrate side or profile views that can correspond to any of the examples 211A-211D of the first part removal device. In the example of FIG. 3A, a first part removal device 211A includes a substantially rectangular sheet including a planar or flat edge. The first part removal device 211A can have a substantially rectangular profile (FIG. 3E), such as to provide a relatively blunt edge. The first part removal device 211A can have a substantially tapered profile (FIG. 3F), such as to provide a tapered or knife-end edge.

In the example of FIG. 3B, the first part removal device 211B includes a substantially rectangular sheet including a serrated or tooth edge. In the example of FIG. 3C, the first part removal device 211C includes multiple separate fingers or extensions. In the example of FIG. 3D, the first part removal device 211D includes an angled edge. Any of the examples 211B-211D can have a substantially rectangular profile (FIG. 3E) or a tapered profile (FIG. 3F). Any of the first part removal devices 211A-211D includes a combination of rectangular and tapered portions at the edge. For example, the first part removal device 211C with the multiple fingers can include some fingers having rectangular profiles and other fingers having tapered profiles. The pitch or slope of the tapered edge can be selected, for example, based on one or more characteristics of a part composite that is to be removed from the conveyable build sheet 185 using the tapered tool.

The first part removal device 211 (e.g., include any one of the configurations shown in FIGS. 3A-3F, among others) can be formed using metal, plastic, rubber, or other rigid or semi-rigid material. The first part removal device 211 includes a stainless steel or aluminum sheet portion. The first part removal device 211 optionally includes a rubberized or plasticized edge configured to impinge on a part composite, such as can be selected to prevent damaging the surface of the part composite at a location where the first part removal device 211 impinges on the part.

The first part removal device 211 can be configured to oscillate or vibrate, such as when the first part removal device 211 is in proximity to or in contact with a part composite that is to be removed from the conveyable build sheet 185. By oscillating or vibrating the first part removal device 211, the part composite can be further encouraged to dislodge or separate from the conveyable build sheet 185. The first roller 221 can be configured to oscillate or vibrate.

The first part removal device 211 can be configured to move in the direction of the process flow so as to gradually apply a removal force to the first part composite 281A as the part approaches an end, or a direction change, of the conveyable build sheet 185. For example, the first part removal device 211 can apply a first lesser removal or vibration force when the first part removal device 211 initially contacts the first part composite 281A and, as the first part composite 281A nears the end of the conveyable build sheet 185, the first part removal device 211 can apply a second greater removal or vibration force to the first part composite 281A.

One or more portions of a part composite can be designed or selected to receive the first part removal device 211. For example, a part composite can have a delicate or fragile feature on a first side and a substantially solid planar surface on a different side of the part. To reduce the risk of damaging the part composite, the part composite can optionally be built on the conveyable build sheet 185 such that when the built part is conveyed to a downstream process, such as including to a part removal portion of the system, the substantially solid planar surface is configured to encounter the first part removal device 211 before any other portion of the part composite. A part composite can be designed with the part removal device in mind, and one or more mechanical features of the part composite can be configured to receive a part removal device (e.g., using a lip or recess feature in the part composite), or the part composite can include a reinforcement feature (e.g., an internal rib feature) to strengthen a portion of the part composite that will impinge on the part removal device. The orientation of the first part composite 281A on the conveyable build sheet 185 can be specified manually, or can be determined automatically, for example, using the control circuit 150.

In an example 202 of FIG. 2B, the conveyable build sheet 185 can move a second part composite 281B in a process flow direction. The conveyable build sheet 185 can include a “bump” portion that is configured to dislodge or separate the second part composite 281B from the surface of the conveyable build sheet 185. A series of bump portions, such as having different heights, can be used.

In the example of FIG. 2B, the conveyable build sheet 185 can be configured to move atop multiple rollers, such as including a first roller 231 and a second roller 232. The first and second rollers 231 and 232 can be similarly or differently sized. A third roller 233 can be interposed between the first and second rollers 231 and 232. The third roller 233 can be sized or positioned such that the conveyable build sheet 185 is sloped on at least one side of the third roller 233. In the example of FIG. 2B and in the process flow direction, the conveyable build sheet 185 is sloped upward on a first side of the third roller 233, and the conveyable build sheet 185 is sloped downward on a subsequent second side of the third roller 233.

As the second part composite 281B is conveyed over the third roller 233, and depending upon a tension characteristic of the conveyable build sheet 185, the second part composite 281B can be caused to separate or detach from the conveyable build sheet 185 as the direction of the sheet changes beneath the surface of the part. A series of rollers at different heights can be provided to further separate the second part composite 281B from the conveyable build sheet 185. The third roller 233, and any of the additional rollers along the conveyable build sheet 185, can be configured to vibrate or oscillate to facilitate separating the second part composite 281B from the conveyable build sheet 185. A series of peaks and valleys in the travel of the conveyable build sheet 185 can be provided, such as to provide a substantially corrugated or rippled surface to facilitate the separation.

In an example 203 of FIG. 2C, the conveyable build sheet 185 can move a third part composite 281C in the process flow direction. The conveyable build sheet 185 can include a detent or recessed portion that is configured to dislodge or separate the third part composite 281C from the surface of the conveyable build sheet 185. In the example of FIG. 2C, the conveyable build sheet 185 can be configured to move atop multiple rollers, such as including a first roller 241 and a second roller 242. The first and second rollers 241 and 242 can be similarly or differently sized. A removal feature 243 can be interposed between the first and second rollers 241 and 242. The removal feature 243 can optionally include a third roller, a plate, knife, bar, or other feature configured to provide the detent or recessed portion in the conveyable build sheet 185.

As the third part composite 281C is conveyed over the removal feature 243, the third part composite 281C can be caused to separate or detach from the conveyable build sheet 185 as the direction of the sheet changes beneath the surface of the part. The removal feature 243 can include a series of rollers at similar or different heights to further separate the third part composite 281C from the conveyable build sheet 185. The removal feature 243, and any of the additional rollers along the conveyable build sheet 185, can be configured to vibrate or oscillate to facilitate separating the third part composite 281C from the conveyable build sheet 185. A series of peaks and valleys in the conveyable build sheet 185 can be provided using the removal feature 243, such as to provide a substantially corrugated or rippled surface to facilitate the separation.

In an example 204 of FIG. 2D, the conveyable build sheet 185 can move a fourth part composite 281D in the process flow direction. An end of the conveyable build sheet 185 can be aligned with or abut an end of a second conveyor 285, and the ends of the conveyable build sheet 185 and the second conveyor 285 can be positioned sufficiently proximate to each other that a part composite on the conveyable build sheet 185, such as the fourth part composite 281D, can be exchanged from the conveyable build sheet 185 to the second conveyor 285. A top surface of the conveyable build sheet 185 can be coplanar with a top surface of the second conveyor 285, or the top surface of the second conveyor can be offset (e.g., positioned below) from the top surface of the conveyable build sheet 185. A part removal device, such as the first part removal device 211, can be positioned at the junction between the conveyable build sheet 185 and the second conveyor 285.

A roller or other feature at or near an end of one or both of the conveyable build sheet 185 and the second conveyor 285 can be configured to oscillate or vibrate. For example, one or both of a first roller 251 at an end of the conveyable build sheet 185 or a second roller 252 at an end of the second conveyor 285 can oscillate or vibrate to facilitate removing the fourth part composite 281D from the conveyable build sheet 185.

Any of the techniques described in the examples of FIGS. 2A-2D can be combined or used in series. For example, the removal feature 243 from the example of FIG. 2C can be positioned just before the first roller 251 in the example of FIG. 2D, such as to remove a part composite from the conveyable build sheet 185 and then to exchange the removed part composite with a different conveyor. The first part removal device 211 can be positioned at a downward-sloped portion of the third roller 233 in the example of FIG. 2B. Other permutations or combinations can be similarly used.

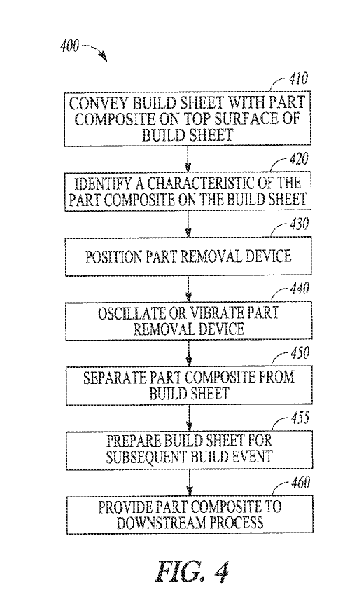

FIG. 4 illustrates generally an example of a method 400 that can include using a part removal device to separate or remove a part composite from a substrate. At 410, the method includes conveying a build sheet through a portion of an additive manufacturing system. For example, at 410, a part composite, such as the part composite 181, can be conveyed away from the build area 180 of the additive manufacturing system 100 using the conveyable build sheet 185.

At 420, the method can optionally include identifying a characteristic of the part composite that is on the build sheet conveyed at 410. Information about the identified characteristic of the part composite can be used to select an appropriate position for or type of part removal device to use with the part composite. Identifying the characteristic can include identifying one or more of a part type, part mass, part color, material type, material orientation, part thickness, part orientation on the build sheet, or other characteristic of the part composite. A machine vision system or other optical sensor can be used to identify the characteristic. An electronic sensor can be used to identify the characteristic. For example, a scale or other mass sensor can be configured to measure a mass of the part composite, such as while the part is conveyed at 410. The sensor can generate a signal indicative of the identified characteristic, and can provide the signal to the control circuit 150.

In some examples, a part removal device can be static or can be maintained in a fixed location. In other examples, the part removal device can be movable between multiple different locations or orientations relative to the build sheet and relative to the part to be separated from the build sheet. At 430, the method can optionally include positioning a part removal device to facilitate separating or dislodging a part composite from the build sheet. For example, at 430, the method can include positioning the first part removal device 211 at a location at or near a turn in the conveyable build sheet 185, as similarly shown in the example of FIG. 2A. Positioning the part removal device can including using a robotic arm, linear actuator, pneumatic device, or other system or device to locate the part removal device, such as based on instructions from the control circuit 150.

At 440, the method can optionally include oscillating or vibrating the part removal device. The part removal device includes a rigid plate, and the plate can be vibrated when the part removal device is in contact with, or in close proximity to, a part composite that is on the build sheet. A vibration force, magnitude, or direction characteristic can be adjusted based on a characteristic of the part composite. For example, a greater vibration force can be used with a large, solid part composite, and a lesser vibration force can be used with a smaller or more delicate part composite. Oscillating or vibrating the part removal device can include moving the part removal device back and forth along a single axis, or it can include moving the part removal device along multiple axes, or in a circular or elliptical manner.

At 450, the method includes separating all or a portion of the part composite from the build sheet. The part removal device can be withdrawn before the part composite is completely separated from the build sheet. The part removal device can be positioned along the build sheet in a region that is occupied by a portion of the part composite, and that corresponding portion of the part composite can be dislodged from the build sheet. multiple part removal devices can be arranged serially along the build sheet, such as to remove different portions of a single part composite, or to remove multiple different part composites disposed on the build sheet.

At 455, the method optionally includes preparing the build sheet for a subsequent build event. At 455, preparing the build sheet can include clearing, stripping, or cleaning the build sheet to remove any residual model or support material, such that the build sheet is sufficiently clean and can be reused for constructing a different part composite. preparing the build sheet at 455 includes using a chemical solution to dissolve any residual material or to cleanse the build sheet surface. preparing the build sheet at 455 includes using mechanical means, such as using a scraper or brush.

At 460, the method includes providing the part composite to a downstream process in the additive manufacturing system. Among other things, some of which are described herein, the downstream process can include cleaning, sorting, drying, smoothing, painting, or otherwise processing the part composite after the part composite is separated from the build sheet.

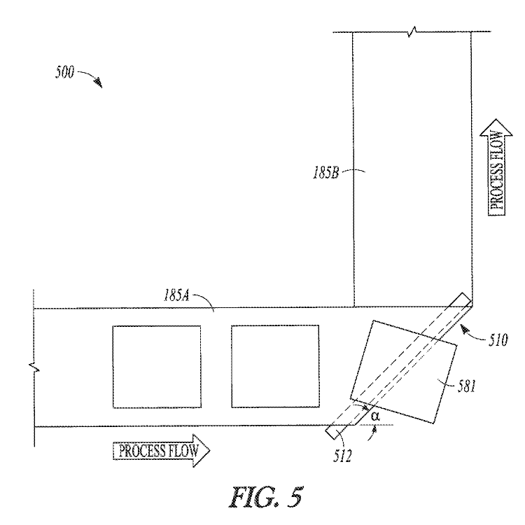

FIG. 5 illustrates generally an example 500 of a portion of a system that can be used to separate, or to facilitate separating, a part composite 581 from a conveyable build sheet. The conveyable build sheet in the example of FIG. 5 includes a top surface 185A and a bottom surface 185B. An upstream process can build, process, or position the part composite 581 on the top surface 185A of the conveyable build sheet.

A first path segment of the conveyable build sheet can extend from the upstream process to a belt direction change location 510. At the belt direction change location 510, the belt can be rotated, twisted, turned, or otherwise configured to proceed in a direction of a second path segment that is non-parallel to the direction of the first path segment. A direction change roller 512 can be provided at the belt direction change location 510. The top surface 185A of the conveyable build sheet can move over a surface of the direction change roller 512, and can optionally wrap under the plane of the top surface 185A in the first path segment, as shown in FIG. 5.

In some examples, the part composite 581 can be removed from the top surface 185A of the conveyable build sheet at the belt direction change location 510. The direction change roller 512 can be provided at an angle α relative to the direction of the conveyable build sheet in the first path segment. For example, the direction change roller 512 can be oriented at about 45 degrees relative to the direction of the conveyable build sheet such that the second path segment extends substantially orthogonally to the first path segment. Depending on the characteristics of the part composite 581, a relatively small initial portion of the part composite 581 can arrive at the direction change roller 512. The top surface 185A of the conveyable build sheet can be peeled away from the bottom surface of the part composite 581 as the part composite 581 is conveyed in the direction of the first path segment. As the part composite 581 passes or travels over the direction change roller 512, such as substantially in the direction of the first path segment, the part composite 581 can be dropped into a receptacle, picked by a robotic arm, or received on a subsequent conveyor (see, e.g., FIG. 2D).

The angle α of the direction change roller 512 can be selected according to a characteristic of the part composite 581, and the angle α can optionally be adjustable. The angle α can be adjusted during a process or build event. The angle change can coordinated with spaces between different, serially-arranged part composites on the top surface 185A of the conveyable build sheet.

A part removal device (see, e.g., FIGS. 2A-2D) can be used in combination with the conveyable build sheet of FIG. 5. For example, the part removal device 211D, shown in the example of FIG. 3D, can be positioned with its end edge near or coincident with the location of the direction change roller 512. The direction change roller 512 can be caused to vibrate or oscillate as the part composite 581 traverses the roller. The vibration or oscillation can further facilitate separating the part composite 581 from the top surface 185A of the conveyable build sheet.

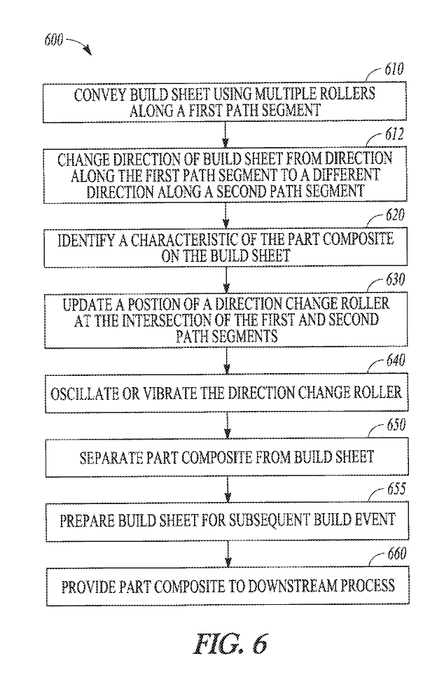

FIG. 6 illustrates generally an example of a method 600 that can include using a part removal device to separate or remove a part composite from a substrate. At 610, the method includes conveying a build sheet through a portion of an additive manufacturing system, including along a first path segment. For example, at 610, a part composite, such as the part composite 181, can be conveyed away from the build area 180 of the additive manufacturing system 100 using the conveyable build sheet 185.

At 612, the method 600 includes changing the direction of the build sheet from a direction of the first path segment to a different direction of a second path segment. The first and second path segments can be non-parallel and, in an example, the first and second path segments can be substantially orthogonal to each other. A direction change roller can optionally be provided at the location of the build sheet direction change. Such as shown in FIG. 5, the surfaces of the build sheet in the first and second path segments can be substantially horizontal. The surface in the first path segment can be substantially horizontal, and the surface in the second path segment can be substantially vertical.

At 620, the method can optionally include identifying a characteristic of the part composite that is on the build sheet conveyed at 610. Identifying the characteristic can include identifying one or more of a part type, part mass, part color, material type, material orientation, part thickness, part orientation on the build sheet, or other characteristic of the part composite. A machine vision system or other optical sensor can be used to identify the characteristic. An electronic sensor can be used to identify the characteristic. For example, a scale or other mass sensor can be configured to measure a mass of the part composite, such as while the part is conveyed at 610. The sensor can generate a signal indicative of the identified characteristic, and can provide the signal to the control circuit 150.

In some examples, a direction change roller can be static or maintained in a single location. In other examples, the direction change roller can be movable between multiple different locations or orientations relative to the first or second path segments of the conveyable build sheet. At 630, the method can optionally include updating a position of a direction change roller. For example, at 630, the method can include positioning the direction change roller at a first angle α₁, such as in response to information about the part composite on the conveyable build sheet in the first path segment of the build sheet. The control circuit 150 can provide roller position instructions to a motor or other automated device that is coupled to and configured to change a position of the direction change roller.

At 640, the method can optionally include oscillating or vibrating the direction change roller. A vibration force or magnitude characteristic can be adjusted based on a characteristic of the part composite to be separated from the build sheet. For example, a greater vibration force can be used with a large, solid part composite, and a lesser vibration force can be used with a smaller or more delicate part composite. The oscillating or vibrating the direction change roller can include moving the direction change roller along multiple axes, or in a circular or elliptical manner.

At 650, the method includes separating all or a portion of the part composite from the build sheet as the part composite traverses the direction change roller between the first and second segment paths.

At 655, the method optionally includes preparing the build sheet for a subsequent build event. At 655, preparing the build sheet can include clearing, stripping, or cleaning the build sheet to remove any residual model or support material, such that the build sheet is sufficiently free of debris and can be reused for constructing a different part composite. Preparing the build sheet at 655 includes using a chemical solution to dissolve any residual material or to cleanse the build sheet surface, or preparing the build sheet includes using mechanical means, such as using a scraper or brush, at or near the direction change roller 512.

At 660, the method includes providing the part composite to a downstream process in the additive manufacturing system. Among other things, some of which are described herein, the downstream process can include cleaning, sorting, drying, painting, or otherwise processing the part composite.

A part composite can include model material only or can include a combination of model material and support material. After a build event, the part composite can be cleaned, coated, smoothed, painted, or otherwise processed, such as automatically using a processing station on an assembly line. In some examples, the processing station can include an agent dispenser or a reservoir for an agent. The agent can include a solvent, and the solvent can be selected to dissolve or remove the support material from the model material of the part composite. The solvent can include, among other things, an acidic, basic, or pH-neutral solution, water, glycol, methyl ethyl ketone (MEK), sodium hydroxide, vinegar, or lye.

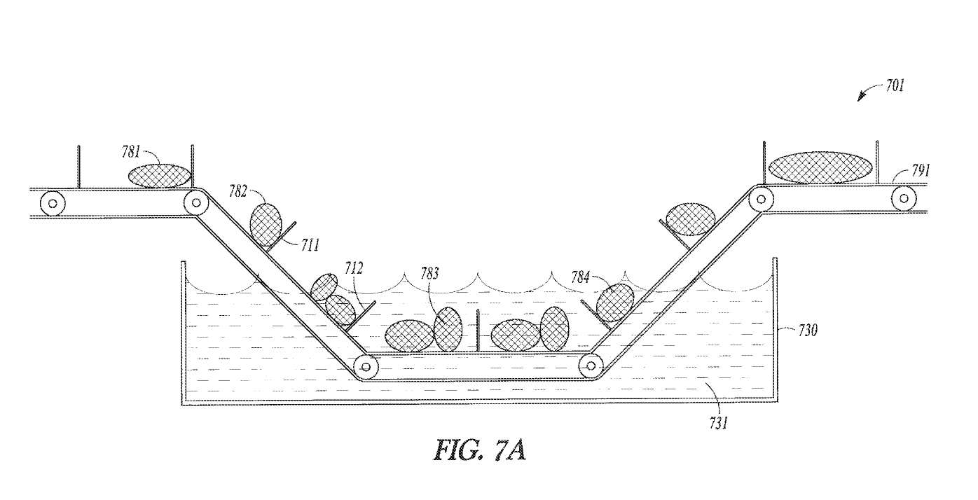

Various systems and methods can be used to apply a solvent or other material (e.g., a colorant, paint, plating, or other chemical in liquid or powder form) to a part composite. FIG. 7A, for example, includes a conveyor system 701 that includes a belt portion that can be submerged in an agent tank 730. FIG. 7B includes a conveyor system 702 with a belt portion that can be moved under a dispenser nozzle 750 that is configured to dispense an agent.

In the example of FIG. 7A, multiple part composites 781, 782, 783, and 784, among others, are disposed on a surface of a first conveyor 791. The multiple part composites 781-784 can be similarly or differently constructed from model material and optionally from model and support material. The multiple part composites 781-784 can be built on the surface of the first conveyor 791, or the multiple part composites 781-784 can be built on a different surface, removed from the different surface, such as using one or more of the systems and methods described herein, and positioned on the first conveyor 791 for further processing.

The first conveyor 791 includes multiple dividers, including at least a first divider 711 and a second divider 712, that define compartments or regions in which one or more part composites can be disposed. The dividers are coupled to a surface of the first conveyor 791. In some examples, baskets, buckets, or other part-holding devices can be placed on top of the first conveyor 791, such as additionally or alternatively to the multiple dividers.

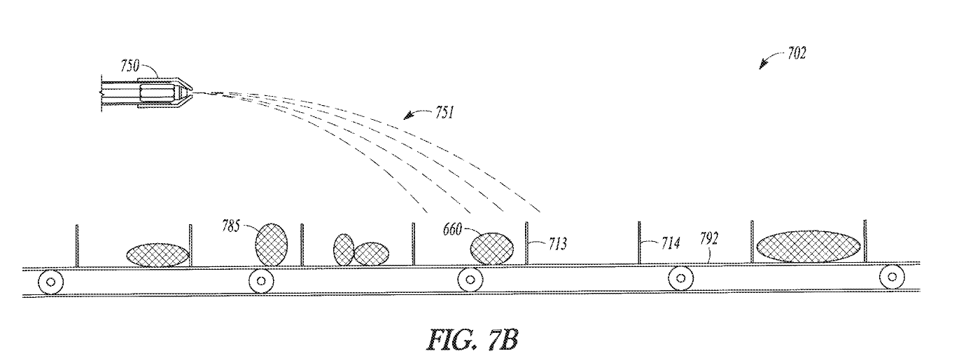

FIGS. 8A-8C illustrate generally examples of front views of multiple different dividers, such as the first and second dividers 711 and 712. A divider generally includes a rigid or semi-rigid plate, although other dividing or separating devices can be used. For example, a divider can include a recessed or raised portion in a corrugated surface of a conveyor belt.

In the example of FIG. 8A, a solid plate divider 811A includes a generally rectangular plate having a solid front face with no open area or perforations. A divider with some open surface area can be used to promote agent flow around a part composite, or to avoid pooling of excess agent. In the example of FIG. 8B, a mesh divider 811B includes a generally rectangular plate having a larger open surface area than closed or solid surface area. In the example of FIG. 8C, a perforated divider 811C includes a generally rectangular plate having an open surface area that is approximately equal to the closed surface area of the plate. The size of the openings in the perforated divider 811C can be selected based on the part composite and/or agent to be used. A conveyor belt forming a portion of the first conveyor 791 or the second conveyor 792 can be similarly made of a mesh material or a perforated material.

Referring again to FIG. 7A, the first conveyor 791 can be directed into the agent tank 730 using a system of rollers or other conveyor-directing means. The first conveyor 791 can include one or more sloped portions, as shown in the example of FIG. 7A. The multiple dividers can be selected to be sufficiently rigid such that the part composite(s) between the dividers can be held in place as the conveyor transitions up or down the sloped portions of the conveyor. The first conveyor 791 and any part composite disposed on the first conveyor 791 can be submerged in the agent 731 of the agent tank 730.

The agent tank 730 can include a liquid, gas, powder, or other agent 731 through which the first conveyor 791, the multiple dividers, and the part composites can move. The agent tank 730 can include an agitator or one or more agent sources (e.g., jets, nozzles, etc.) that can be configured to move the agent 731 about in the agent tank 730, such as to increase contact between the agent 731 and a part composite in the agent tank 730.

FIG. 7B illustrates generally an example 702 that can include a second conveyor 792. The second conveyor 792 can optionally include a third divider 713 and a fourth divider 714. The third and fourth dividers 713 and 714 can be the same or different dividers than the first and second dividers 711 and 712 described above in the discussion of FIG. 7A.

The dispenser nozzle 750 can be configured to dispense an agent stream 751 in a direction of a top surface of the second conveyor 792. The top surface can include one or more part composites, such as a fifth part composite 785. As described above, the dispensed agent can include, among other things, a solvent configured to dissolve a support material, a colorant, a cleanser, or some other material configured to change a characteristic of a part composite.

The dispenser nozzle 750 can be a high pressure nozzle and/or a high volume nozzle that is configured to release a pressurized agent in the direction of the second conveyor 792. For example, the dispenser nozzle 750 can include a nozzle suitable for a power washing application. In some examples, the dispenser nozzle 750 can release a high volume shower or “waterfall” of agent over the second conveyor 792.

The angle of the agent stream 751 can be adjustable, and can be selected based on a position of the dispenser nozzle 750 relative to the second conveyor 792, and/or relative to a part composite disposed on the second conveyor 792. A control signal from the control circuit 150 can be received at an actuator coupled to the dispenser nozzle 750, and in response, the dispenser nozzle 750 can be automatically moved.

The examples of FIGS. 7A and 7B can be used together with one or more part composite sensors. The one or more part composite sensors can be configured to provide information about a presence or absence of one or more part composites disposed on the first or second conveyors 791 or 792, or about a characteristic of the one or more part composites. Information from a sensor can trigger an agitator in the agent tank 730 to begin or stop agitating the agent 731, or the sensor can trigger the dispenser nozzle 750 to release the agent stream 751. information about a characteristic of the one or more part composites can be used to select a depth of the agent tank 730, an angle of the dispenser nozzle 750, or a speed of the conveyors.

A sensor can be configured to sense whether a support material is sufficiently removed from a model material of a specified part composite that is disposed on the first conveyor 791. In response to information from the sensor about the support material, the control circuit 150 can provide instructions to a drive system for the first conveyor 791 to adjust a speed of the first conveyor 791. If the support material is sufficiently dissolved or removed and the part composite is still in the agent tank 730, then the control circuit 150 can increase the speed of the first conveyor 791. If the support material is not completely dissolved or removed and the part composite is nearing the upward slope out of the agent tank 730, then the control circuit 150 can slow or stop the first conveyor 791 so that the part composite can have more time to receive the agent 731.

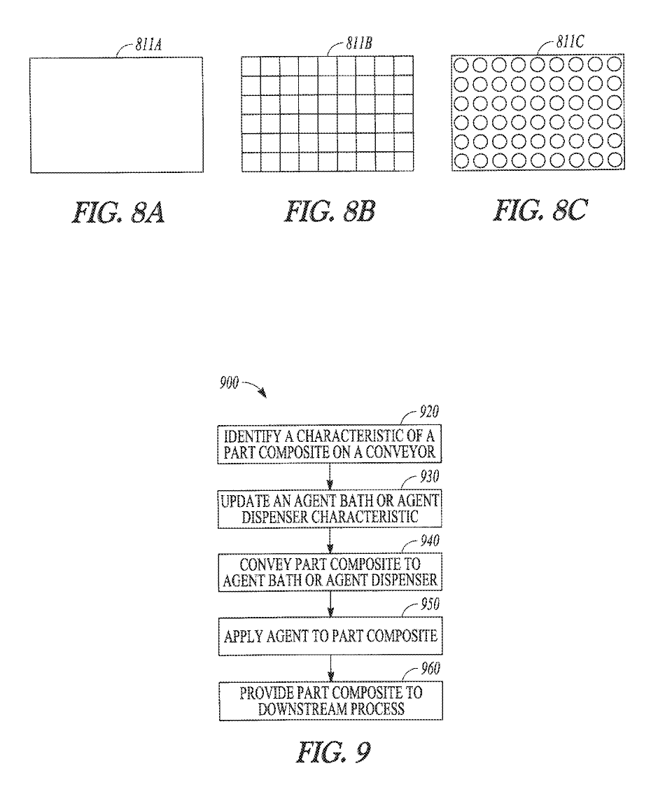

FIG. 9 illustrates generally an example of a method 900 that includes applying an agent to a part composite. At 920, the method optionally includes identifying a characteristic of a part composite on a conveyor. For example, one or more sensors can be used to identify a part composite or to identify a part composite feature of a part disposed on a conveyor. At 930, information about the part composite identified at 920 can be used to update an agent bath or agent dispenser characteristic. For example, a depth of the agent bath can be adjusted, or an orientation or type of dispenser nozzle can be adjusted based on the identified characteristic.

At 940, the part composite can be conveyed, such as using a perforated conveyor belt, to the agent bath or the agent dispenser. At 950, the agent can be applied to the part composite, such as using a pressurized stream from the dispenser nozzle, or by submerging all or a portion of the part composite in the agent bath. At 960, the part composite can be removed from the agent bath, or the dispenser nozzle can stop releasing an agent stream. The part composite can then be provided to a downstream process for further processing.

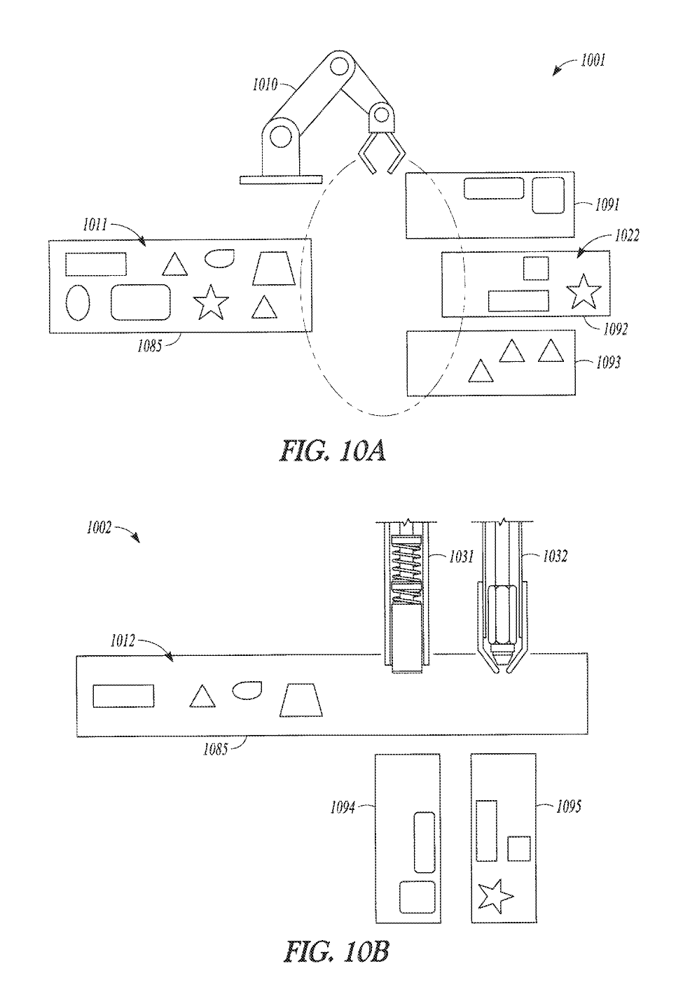

FIGS. 10A-10C illustrate generally examples of systems or sorting stations that can be used to sort or relocate one or more part composites in an assembly line. Each of the examples of FIGS. 10A-10C includes an input area. Multiple different part composites can be brought to or stored at the input area. A conveyor can be configured to bring one or more part composites to the input area. A sorting device can be provided to direct the multiple different part composites to respective ones of two or more different receiving areas, such as depending upon a characteristic of each of the different part composites.

The sorting device can sort multiple part composites into the different receiving areas according to a part characteristic, such as one or more of a visual characteristic, an orientation, a dimension, a weight, or some other feature of a part. One or more sensors can be provided to sense or receive information about a part characteristic, and the information can be used by the control circuit 150 to provide instructions to the sorting device. The sorting device can use information about multiple characteristics of a part composite to select an appropriate one of multiple different receiving areas in which to deposit the part.

A characteristic can include a visual characteristic that can be recognized using a machine vision system. The visual characteristic can include printed indicia on a part surface. For example, the printed indicia can include text, a symbol, or a bar code (e.g., 2D or 3D), among other printed features. The visual characteristic can include a part composite shape, color, geometry, or dimension. The visual characteristic can include information about a part orientation, such as relative to a direction of travel of a conveyor upon which the part composite is positioned.

Information from a CAD model of a part composite can be used to generate instructions for operating a sorting device. For example, the control circuit 150 can be configured to determine or receive information about a visual characteristic of a part composite from a CAD model of the same part composite. A dimension characteristic of a part composite can be retrieved from a CAD model of the part composite, such as the same CAD model used to generate instructions for creating the part by an additive manufacturing process. The retrieved dimension characteristic can be used by the sorting device to identify a specified part composite from among other part composites.

A characteristic can include a layer count or a layer thickness, and the sorting device can include a sensor configured to measure information about one or more layers comprising a part composite. Based on the characteristic information about the layer count or the layer thickness, the sorting device can selectively sort the part composite to one of multiple different receiving areas.

A characteristic can include a weight of a part composite. A scale or other weight sensor can be configured to sense information about a weight or mass of a part composite and, in response, the sorting device can selectively sort the part composite to one of multiple different receiving areas.

FIG. 10A illustrates a first sorting station 1001. The first sorting station 1001 includes a robotic arm 1010 and an input area with a conveyor 1085. The conveyor 1085 can have one or more part composites 1011 disposed on its top surface. The robotic arm 1010 can include a hand, vacuum, or other feature configured to pick up one or more of the part composites 1011 and relocate the one or more of the part composites 1011 to one of multiple different receiving areas. In the example of FIG. 10A, the robotic arm 1010 can relocate one or more of the part composites 1011 to one of a first receiving area 1091, a second receiving area 1092, and a third receiving area 1093. Fewer or additional receiving areas can similarly be used. Any of the receiving areas discussed herein can include a conveyor, a receptacle, a chute, a package, or some other mechanism for receiving or moving one or more part composites.

The robotic arm 1010 can operate in response to a signal from the control circuit 150. Information from a part composite sensor can be received at the control circuit 150, processed, and in response, instructions can be provided to the robotic arm 1010, for example, to pick up a specified part composite at a specified location on the conveyor 1085. Each of the receiving areas 1091-1093 can be configured to receive a specified type of part composite or a specified number of part composites. For example, the robotic arm 1010 can be configured to retrieve any rectangular parts with rounded edges from the conveyor 1085 and place only those rectangular parts with rounded edges in the first receiving area 1091.

A receiving area can receive a kit of multiple parts from the conveyor 1085. The multiple parts can have some specified characteristic(s). In the example of FIG. 10A, the robotic arm 1010 can be configured to retrieve, as a kit, one star-shaped part composite and two rectangular part composites, and to place only those parts in the second receiving area 1092. Once the kit is complete, as shown in the example of FIG. 10A at 1092, then the kit of parts 1022 can be provided downstream for further processing. The second receiving area 1092 includes a second conveyor, and the kit of parts 1022 can be driven down the process line on the second conveyor after the kit is complete.

FIG. 10B illustrates a second sorting station 1002. The second sorting station 1002 can include the conveyor 1085 and one or more actuators configured to move or dislocate one or more part composites from the conveyor 1085. The conveyor 1085 can have one or more part composites 1012 disposed on its top surface, such as serially-arranged part composites 1012 as shown. In the example of FIG. 10B, the second sorting station 1002 includes first and second actuators 1031 and 1032, and the actuators are configured to selectively provide a force, in the direction of a part composite on the conveyor 1085, that is sufficient to move the part composite.

The first actuator 1031 includes a spring-loaded or pneumatic actuator with a retractable piston that is operable in the direction of a part composite on the conveyor 1085. As a first part composite is conveyed in front of the piston head of the first actuator 1031, the piston can be actuated to push the first part composite toward a fourth receiving area 1094. Any of the size of the piston head, the speed or force with which the piston extends across the conveyor, or an angle of the piston relative to the conveyor 1085, among other characteristics, can be adjusted in response to a type of part composite to be moved.

The second actuator 1032 includes a nozzle that is configured to dispense one of a liquid or a gas in the direction of a part composite on the conveyor 1085. As a second part composite is conveyed in front of the nozzle head of the second actuator 1032, a pressurized liquid or gas can be released to push the second part composite toward a fifth receiving area 1095. Any of the size of the nozzle, the speed or force with which the liquid or gas is released from the nozzle, or an angle of the nozzle relative to the conveyor 1085, among other characteristics, can be adjusted in response to a type of part composite to be moved. The conveyor 185 can be tilted in the direction of the fourth and fifth receiving areas 1094 and 1095 to facilitate movement of a part composite toward a respective one of the receiving areas once a static friction between the part composite and conveyor 1085 surface is overcome due to a force from one of the first or second actuators 1031 or 1032.

FIG. 10C illustrates a third sorting station 1003. The third sorting station 1003 can include the conveyor 1085 and a movable guide 1035 configured to move one or more part composites from the conveyor 1085. The conveyor 1085 can have one or more part composites 1013 disposed on its top surface, such as serially-arranged part composites 1013 as shown. In the example of FIG. 10C, the movable guide 1035 is configured to rotate between at least first and second positions to selectively direct one or more part composites from the surface of the conveyor 1085 to one of a sixth or a seventh receiving area 1096 or 1097. In the illustration of FIG. 10C, the movable guide 1035 is positioned such that a part composite on the conveyor 1085 will be directed toward the seventh receiving area 1097.

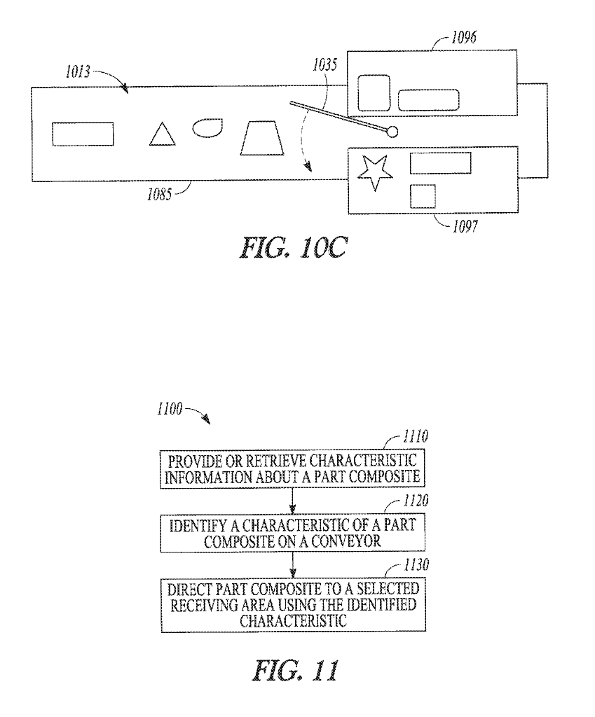

FIG. 11 illustrates generally an example 1100 that can include using a sorting device to direct one or more part composites to one or more different locations in an additive manufacturing system or post-processing system. At 1110, the method includes providing or retrieving characteristic information about a part composite. The characteristic information can include, among other things, information about one or more of a part size, shape, color, weight, or material type. The characteristic information can be provided, such as to the control circuit 150, manually by an operator, or the characteristic information can be retrieved, such as automatically using the control circuit 150. Retrieving the characteristic information can include retrieving the characteristic information from a CAD file or from an upstream process or device that can include information about the part composite.

At 1120, the method can include identifying a characteristic of a part composite. Identifying the characteristic can include identifying one or more of a part type, part mass, part color, material type, material orientation, part thickness, part orientation, or other characteristic of the part composite. A machine vision system or other optical sensor can be used to identify the characteristic. An electronic sensor can be used to identify the characteristic. For example, a scale or other mass sensor can be configured to measure a mass of the part composite. The sensor can generate a signal indicative of the identified characteristic, and can provide the signal to the control circuit 150.

At 1130, the method can include directing the part composite to a selected receiving area in an additive manufacturing system based on the characteristic identified at 1120. The part composite can be directed using a mechanical device that is configured to pick, push, pull, or otherwise cause a sufficient force to act on a part composite so as to move the part from a first to a second location. A pressurized airflow or vacuum force can be applied to move the part composite, such as using one of the first and second actuators 1031 and 1032. Some of the systems that can be configured for directing the part composite are illustrated generally in the examples of FIGS. 10A, 10B, and 10C.

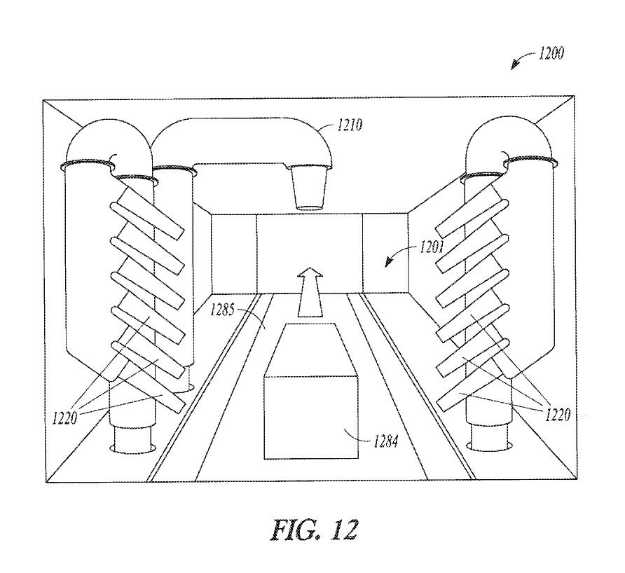

FIG. 12 illustrates generally an example that can include a drying station 1200 for use in an automated additive manufacturing system. The drying station 1200 includes a drying area 1201 that is sized and shaped to receive a part composite from an upstream portion of an additive manufacturing system. The drying area 1201 is configured to receive a part composite after a cleansing or rinsing operation is performed on the part composite. A conveyor 1285 passes through the drying area 1201 such that a part composite riding the conveyor 1285 is dried using the drying station 1200.

The example of FIG. 12 includes a first drying device 1210 that is configured to direct one of a positive or negative airflow in the direction of a part composite 1284 in the drying area 1201. In the example of FIG. 12, the first drying device 1210 includes an overhead nozzle configured to direct a positive airflow in the direction of the top surface of the conveyor 1285. The first drying device 1210 can optionally be located elsewhere, or can be movable about the conveyor 1285.

One or more additional drying devices 1220 can be provided about the conveyor 1285, such as to provide additional positive or negative airflow in the direction of the part composite 1284 on the conveyor 1285. Any one or more of the drying devices 1210 and 1220 can include a high pressure nozzle and/or a high volume nozzle that is configured to release a pressurized gas in the direction of the conveyor 1285. Any one or more of the drying devices 1210 and 1220 can be alternatively or additionally configured to release a pressurized liquid, solvent, or other material in the direction of the part composite 1284. A material released from at least one of the drying devices 1210 and 1220 includes a heated or cooled gas.

The conveyor 1285 can optionally include a weight sensor that is configured to measure a weight of a part composite in the drying area 1201 of the drying station 1200. A known or specified weight of the part composite 1284 can include a dry weight. The known dry weight information can be retrieved or derived from a CAD model of the part composite 1284. If the actual weight, as measured by the weight sensor, is greater than the expected dry weight of the part composite 1284, then the drying station 1200 can be activated and the part composite 1284 can be dried using one or more of the drying devices 1210 and 1220. The part composite 1284 can receive airflow until the actual weight, as measured by the weight sensor, is about the same as the expected dry weight of the part composite. At least one of the drying devices 1210 and 1220 is configured to provide desiccant air or some other gas to encourage the part composite 1284 to dry rapidly. A rate, volume, direction, or other characteristic of the airflow or vacuum from the drying devices 1210 and 1220 can be adjusted.

Many of the systems and methods described herein can be combined in series or can be used together in different parts of an additive manufacturing system. For example, a part composite 181 can be manufactured in a build area 180 of the system 100, such as directly on a build surface of a conveyable build sheet 185. The conveyable build sheet 185 can carry the part composite 181 to a part removal device (see, e.g., FIGS. 2A-2D, and FIG. 5) where the part composite 181 can be physically separated, at least in part, from the conveyable build sheet 185. The separated part composite 181 can be further conveyed, using the same or different conveyor, to a processing portion of the system, such as including a solvent configured to remove or dissolve the support material 182 from the model material 184 of the part composite 181. The processing portion of the system can include, for example, a solvent bath area or rinsing area (see, e.g., FIGS. 7A and 7B). From the processing portion of the system, the part composite 181 can optionally proceed to one of a drying station (see, e.g., FIG. 12) or a sorting station (see, e.g., FIGS. 10A-10C).

Polymeric materials that can be used according to the systems, devices, and methods described herein can include high-performance engineering thermoplastic polymers such as polycarbonate-based polymers (PC), polymethyl methacrylate polymers (PMMA), polyethylene terephthalate polymers (PET), polybutylene terephthalate polymers (PBT), styrene polymers, polyetherimide (PEI, ULTEM), acrylic-styrene-acrylonitrile polymers (ASA), and acrylonitrile-butadiene-styrene polymers (ABS). Engineering thermoplastic polymers can be used because they have a relatively high flexural modulus.

Dyes can be applied to the polymeric material to provide for a desired color or color-enhancing effect to the polymeric material. Wen et al., in Provisional U.S. Patent Application No. 61/931,033, filed on Jan. 24, 2014, titled “Photochromic polycarbonate compositions, methods of manufacture, and articles comprising the same”, includes systems and methods for using photochromic dyes in engineering plastics, and is incorporated herein by reference.

An additive composition can be used in the photochromic polycarbonate compositions. The additive composition can comprise one or more additives selected to achieve a desired property, with the proviso that the additive(s) are also selected so as to not overly significantly adversely affect a desired property of the composition, in particular the photochromic properties. The additive composition or individual additives can be mixed at a suitable time during the mixing of the components for forming the composition. The additive can be soluble or non-soluble in polycarbonate.

The additive composition can include an impact modifier, flow modifier, antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination comprising one or more of the foregoing.

In certain embodiments, the photochromic polycarbonate compositions can comprise phosphoric acid.

### VARIOUS NOTES & EXAMPLES

Example 1 can include or use subject matter (such as an apparatus, a method, a means for performing acts, or a device readable medium including instructions that, when performed by the device, can cause the device to perform acts), such as can include or use an automated additive manufacturing system, including a conveyable build sheet configured to receive extruded material from a material extrusion nozzle in a build area. The conveyable build sheet can be movable between the build area and a post-processing area of the system. Example 1 can include a part removal device in proximity to a surface of the conveyable build sheet. The part removal device can be configured to impinge on at least one of the conveyable build sheet and the received extruded material, near a location where the received extruded material contacts the build sheet, to separate a portion of the received extruded material from the conveyable build sheet.

Example 2 can include, or can optionally be combined with the subject matter of Example 1, to optionally include a substantially planar edge of the part removal device, and the substantially planar edge can be spaced apart from the surface of the conveyable build sheet.

Example 3 can include, or can optionally be combined with the subject matter of Example 2, to optionally include the substantially planar edge of the part removal device aligned non-parallel with a direction of travel of the conveyable build sheet.

Example 4 can include, or can optionally be combined with the subject matter of one or any combination of Examples 1 through 3 to optionally include a conveyable build sheet having a flexible substrate. In Example 4, the part removal device can include a substantially planar edge that is configured to impinge on the flexible substrate near the location where the received extruded material contacts the build sheet.

Example 5 can include, or can optionally be combined with the subject matter of one or any combination of Examples 1 through 4 to optionally include the part removal device having multiple tapered fingers that are spaced apart. A narrow side of each of the tapered fingers is configured to impinge on the at least one of the conveyable build sheet and the received extruded material.

Example 6 can include, or can optionally be combined with the subject matter of one or any combination of Examples 1 through 5 to optionally include the conveyable build sheet having a top, build-side surface and an opposite bottom side surface. In Example 6, the part removal device can be configured to impinge on the bottom side surface of the conveyable build sheet near a location where the received extruded material contacts the build sheet.

Example 7 can include, or can optionally be combined with the subject matter of one or any combination of Examples 1 through 6 to optionally include the part removal device having a tapered knife-end edge that is configured to impinge on the at least one of the conveyable build sheet and the received extruded material.

Example 8 can include, or can optionally be combined with the subject matter of one or any combination of Examples 1 through 7 to optionally include a conveyor adjacent to the conveyable build sheet in the post-processing area of the system. The conveyor can be configured to receive, from the conveyable build sheet, the extruded material after the material is separated from the build sheet.

Example 9 can include, or can optionally be combined with the subject matter of Example 8, to optionally include the part removal device positioned at a junction between an end edge of the conveyable build sheet and an adjacent end edge of the conveyor.

Example 10 can include, or can optionally be combined with the subject matter of one or any combination of Examples 1 through 9 to optionally include the conveyable build sheet as a portion of a conveyor belt.

Example 11 can include, or can optionally be combined with the subject matter of one or any combination of Examples 1 through 10 to optionally include the part removal device configured to oscillate or vibrate.

Example 12 can include, or can optionally be combined with the subject matter of one or any combination of Examples 1 through 11 to include, subject matter (such as an apparatus, a method, a means for performing acts, or a machine readable medium including instructions that, when performed by the machine, that can cause the machine to perform acts), such as can include a build sheet in a build area of the automated additive manufacturing system, and the build sheet is configured to receive extruded material from a material extrusion nozzle in an additive manufacturing process. Example 12 further includes a part removal device that is movable between the build area and a storage area, and the part removal device is further movable in the build area in proximity to a planar surface of the build sheet. The part removal device can be configured to impinge on at least one of the build sheet and the received extruded material near a location where the received extruded material contacts the build sheet in order to physically separate a portion of the received extruded material from the build sheet.

Example 13 can include, or can optionally be combined with the subject matter of one or any combination of Examples 1 through 12 to include, subject matter (such as an apparatus, a method, a means for performing acts, or a machine readable medium including instructions that, when performed by the machine, that can cause the machine to perform acts), such as can include a method for separating an extruded material from a build sheet in an automated additive manufacturing system. Example 13 can include conveying a build sheet from a build area of an additive manufacturing system to a post-processing area of the additive manufacturing system, and the build sheet can include a surface having an extruded material deposited thereon from a material extrusion nozzle. Example 13 can include separating the extruded material from the build sheet surface as the build sheet is conveyed from the build area to the post-processing area of the system, including using a part removal device that is positioned in proximity to a surface of the build sheet. The part removal device can be configured to impinge on at least one of the build sheet and the extruded material near a location where the received extruded material contacts the build sheet.

Example 14 can include, or can optionally be combined with the subject matter of Example 13, to optionally include the separating the extruded material from the build sheet using the part removal device includes oscillating or vibrating the part removal device.

Example 15 can include, or can optionally be combined with the subject matter of one or any combination of Examples 13 or 14 to optionally include the separating the extruded material from the build sheet using the part removal device includes using a substantially planar edge of the part removal device that is spaced apart from the build sheet surface.

Example 16 can include, or can optionally be combined with the subject matter of one or any combination of Examples 13 through 15 to optionally include moving the part removal device from a device storage area to the position in proximity to the surface of the build sheet.

Example 17 can include, or can optionally be combined with the subject matter of Example 16, to optionally include identifying a characteristic of the extruded material deposited on the build sheet surface, and moving the part removal device to the position in proximity to the surface of the build sheet, the position determined using the identified characteristic of the extruded material.

Example 18 can include, or can optionally be combined with the subject matter of one or any combination of Examples 1 through 17 to include, subject matter (such as an apparatus, a method, a means for performing acts, or a machine readable medium including instructions that, when performed by the machine, that can cause the machine to perform acts), such as can include a method for separating an extruded material from a build sheet in an automated additive manufacturing system, including using a robotic arm, separating an extruded material from a build sheet surface, wherein the extruded material is deposited on the build sheet surface using a material extrusion nozzle. In Example 18, separating the extruded material from the build sheet surface can include using a tapered edge of a part removal device on the robotic arm. The tapered edge can be configured to impinge on at least one of the build sheet surface and the extruded material near a location where the extruded material contacts the build sheet surface.

Example 19 can include, or can optionally be combined with the subject matter of Example 18, to optionally include, using the robotic arm, moving the separated extruded material to a post-processing area of the automated additive manufacturing system.

Example 20 can include, or can optionally be combined with the subject matter of one or any combination of Examples 18 or 19 to optionally include separating the extruded material using the tapered edge of the part removal device, including oscillating or vibrating the tapered edge of the part removal device.

Example 21 can include, or can optionally be combined with the subject matter of one or any combination of Examples 18 through 20 to optionally include conveying the build sheet surface from a build area to a post-processing area of the automated additive manufacturing system. In Example 21, separating the extruded material from the build sheet surface can include separating the extruded material from the build sheet surface as the build sheet surface is conveyed from the build area to the post-processing area.

Example 22 can include, or can optionally be combined with the subject matter of one or any combination of Examples 1 through 21 to include, subject matter (such as an apparatus, a method, a means for performing acts, or a machine readable medium including instructions that, when performed by the machine, that can cause the machine to perform acts), such as can include a conveyable build sheet configured to receive extruded material from a material extrusion nozzle in a build area, and the conveyable build sheet is movable between the build area of the additive manufacturing system and a post-processing area of the system. Example 22 includes multiple conveyor rollers configured to guide the conveyable build sheet along a path, the path including a first path segment and a second path segment that meet at a first one of the multiple rollers. In Example 22, the first one of the multiple rollers is oriented at a non-orthogonal angle relative to the direction of travel of the build sheet in the first path segment, the first path segment extending between the build area and the post-processing area, and the second path segment contiguous with and extending non-parallel to the first segment.

Example 23 can include, or can optionally be combined with the subject matter of Example 22, to optionally include the non-orthogonal angle of the first one of the multiple rollers, relative to the direction of travel of the build sheet in the first path segment, is about 45 degrees.

Example 24 can include, or can optionally be combined with the subject matter of one or any combination of Examples 22 or 23 to optionally include the non-orthogonal angle of the first one of the multiple rollers, relative to the direction of travel of the build sheet in the first path segment, is less than 45 degrees.

Example 25 can include, or can optionally be combined with the subject matter of one or any combination of Examples 22 through 24 to optionally include a part removal device that is positioned at the first one of the multiple rollers, and the part removal device is configured to impinge on at least one of the conveyable build sheet and the received extruded material, near a location where the received extruded material contacts the build sheet, to separate a portion of the received extruded material from the conveyable build sheet.

Example 26 can include, or can optionally be combined with the subject matter of one or any combination of Examples 22 through 25 to optionally include the first one of the multiple rollers configured to oscillate or vibrate.

Example 27 can include, or can optionally be combined with the subject matter of one or any combination of Examples 22 through 26 to optionally include a second one of the multiple rollers is positioned between the build area and the first one of the multiple rollers, and the second roller is optionally configured to oscillate or vibrate.

Example 28 can include, or can optionally be combined with the subject matter of one or any combination of Examples 1 through 27 to include, subject matter (such as an apparatus, a method, a means for performing acts, or a machine readable medium including instructions that, when performed by the machine, that can cause the machine to perform acts), such as can include a method for separating an extruded material from a build sheet in an automated additive manufacturing system.

Example 29 can include conveying a build sheet from a build area of an additive manufacturing system to a post-processing area of the additive manufacturing system. The build sheet can include a surface having an extruded material deposited thereon from a material extrusion nozzle. Conveying the build sheet can include using multiple conveyor rollers to guide the conveyable build sheet along a path, the path including a first path segment, extending between the build area and the post-processing area, and a second path segment, contiguous with and extending non-parallel to the first segment. The first path segment and the second path segment can meet at a first one of the multiple rollers, and the first one of the multiple rollers can be oriented at a non-orthogonal angle relative to the direction of travel of the build sheet in the first path segment.

Example 30 can include, or can optionally be combined with the subject matter of Example 29, to optionally include vibrating or oscillating the first one of the multiple rollers when the portion of the build sheet surface that includes the extruded material approaches or is disposed at the first one of the multiple rollers.

Example 31 can include, or can optionally be combined with the subject matter of one or any combination of Examples 29 or 30 to optionally include vibrating or oscillating the first one of the multiple rollers when the portion of the build sheet surface that includes the extruded material is conveyed over the first one of the multiple rollers.

Example 32 can include, or can optionally be combined with the subject matter of one or any combination of Examples 29 through 31 to optionally include identifying a characteristic of the extruded material deposited on the build sheet surface, and in response, adjusting the orientation of the first one of the multiple rollers using the identified characteristic of the extruded material.

Example 33 can include, or can optionally be combined with the subject matter of one or any combination of Examples 1 through 32 to include, subject matter (such as an apparatus, a method, a means for performing acts, or a machine readable medium including instructions that, when performed by the machine, that can cause the machine to perform acts), such as can include an automated additive manufacturing system including a conveyor having multiple compartments arranged in series along a length of the conveyor. In Example 33, each of the multiple conveyor compartments can be configured to receive one or more part composites, each part composite comprising a part body portion comprising a build material and a part support portion comprising a support material. Example 33 can include a solvent area that contains, or includes a dispenser for, a solvent that is configured to dissolve the support material or separate the support material from the part body portion comprising the build material. In Example 33, the conveyor can be configured to serially convey the multiple compartments through at least a portion of the solvent area.

Example 34 can include, or can optionally be combined with the subject matter of Example 33, to optionally include the conveyor having a perforated conveyor belt surface.

Example 35 can include, or can optionally be combined with the subject matter of one or any combination of Examples 33 or 34 to optionally include the conveyor having multiple dividers that extend upward from a top surface of the conveyor and are spaced apart along the length of the conveyor. The multiple dividers can be configured to define a separation between adjacent ones of the multiple compartments.

Example 36 can include, or can optionally be combined with the subject matter of Example 35, to optionally include at least one of the multiple dividers includes a perforated divider wall that extends substantially between opposite side edges of the conveyor.

Example 37 can include, or can optionally be combined with the subject matter of one or any combination of Examples 33 through 36 to optionally include multiple solvent dispensers configured to spray the solvent onto the one or more part composites on the conveyor in the solvent area as the conveyor moves through the solvent area.

Example 38 can include, or can optionally be combined with the subject matter of one or any combination of Examples 33 through 37 to optionally include the conveyor submerged in the solvent in the solvent area.

Example 39 can include, or can optionally be combined with the subject matter of one or any combination of Examples 33 through 38 to optionally include a post-processing area downstream from the solvent area, wherein the post-processing area includes, or includes a dispenser for, a basic solution that is configured to cleanse the part body portion comprising the build material.

Example 40 can include, or can optionally be combined with the subject matter of one or any combination of Examples 33 through 39 to optionally include a post-processing area downstream from the solvent area, wherein the post-processing area includes, or includes a dispenser for, a sprayable pH-neutral substance that is configured to cleanse the part body portion comprising the build material.

Example 41 can include, or can optionally be combined with the subject matter of one or any combination of Examples 1 through 40 to include, subject matter (such as an apparatus, a method, a means for performing acts, or a machine readable medium including instructions that, when performed by the machine, that can cause the machine to perform acts), such as can include a sorting station for use in an automated additive manufacturing system. In Example 41, the sorting station can include an input area for receiving multiple different part composites manufactured using one or more additive processes, the multiple different part composites including a first set of one or more first part composites and a second set of one or more second part composites. Example 41 can include a sorting device and first and second receiving areas. The sorting device can be configured to identify a first characteristic of the one or more first part composites and, using information about the identified first characteristic, direct the one or more first part composites to a selected one of the first and second receiving areas, and direct the one or more second part composites to the other one of the first and second receiving areas.

Example 42 can include, or can optionally be combined with the subject matter of Example 41, to optionally include the sorting device configured to identify a different second characteristic of the one or more second part composites and, using information about the identified different second characteristic, direct the one or more second part composites to the other of the first and second receiving areas.

Example 43 can include, or can optionally be combined with the subject matter of one or any combination of Examples 41 or 42 to optionally include, as the first characteristic, a first visual characteristic. In Example 43, the sorting device can include a machine vision device configured to recognize the first visual characteristic, and the sorting device can be configured to use information about the identified first visual characteristic to direct the one or more first part composites to the selected one of the first and second receiving areas.

Example 44 can include, or can optionally be combined with the subject matter of Example 43, to optionally include, as the first visual characteristic, one or more of a printed indicia on a part composite, a part composite shape, a part composite color, a part composite orientation, or a part composite dimension.

Example 45 can include, or can optionally be combined with the subject matter of one or any combination of Examples 43 or 44 to optionally include the sorting device configured to receive information about the first visual characteristic from a CAD model of the one or more first part composites.

Example 46 can include, or can optionally be combined with the subject matter of one or any combination of Examples 41 through 45 to optionally include, as the first characteristic, a first layer thickness, wherein the sorting device includes a layer sensor configured to identify one of the first layer thickness or a count of a number of layers in a portion of one or more of the first part composites, and wherein the sorting device is configured to use information about the identified first layer thickness or the count to direct the one or more first part composites to the selected one of the first and second receiving areas.

Example 47 can include, or can optionally be combined with the subject matter of one or any combination of Examples 41 through 46 to optionally include, as the first characteristic, a first weight, wherein the sorting device includes a weight sensor configured to identify the first weight, and wherein the sorting device is configured to use information about the identified first weight to direct the one or more first part composites to the selected one of the first and second receiving areas.

Example 48 can include, or can optionally be combined with the subject matter of one or any combination of Examples 41 through 47 to optionally include, as the sorting device, a robotic arm configured to move the one or more first part composites to the selected one of the first and second receiving areas.

Example 49 can include, or can optionally be combined with the subject matter of Example 48, to optionally include the robotic arm configured to pick up the one or more first part composites using a vacuum and to deposit the one or more first part composites in the selected one of the first and second receiving areas by releasing the vacuum.

Example 50 can include, or can optionally be combined with the subject matter of one or any combination of Examples 41 through 49 to optionally include a moving conveyor in the input area.

Example 51 can include, or can optionally be combined with the subject matter of one or any combination of Examples 41 through 50 to optionally include the sorting device, including a dispenser for compressed air. The dispenser can be configured to direct an airstream toward a selected one of the first and second sets of part composites and in the direction of an intended one of the first and second receiving areas, and the airstream can have sufficient strength to displace the selected one of the first and second sets of part composites toward the intended one of the first and second receiving areas.

Example 52 can include, or can optionally be combined with the subject matter of one or any combination of Examples 41 through 51 to optionally include the sorting device, including a vacuum device. The vacuum device can be configured to use a suction force to direct a selected one of the first and second sets of part composites in the direction of an intended one of the first and second receiving areas, and the suction force can have sufficient strength to displace the selected one of the first and second sets of part composites toward the intended one of the first and second receiving areas.

Example 53 can include, or can optionally be combined with the subject matter of one or any combination of Examples 1 through 52 to include, subject matter (such as an apparatus, a method, a means for performing acts, or a machine readable medium including instructions that, when performed by the machine, that can cause the machine to perform acts), such as can include a method for sorting part composites produced using an additive manufacturing system. Example 53 can include receiving, in an input area of the additive manufacturing system, multiple different part composites manufactured using one or more additive processes, the multiple different part composites comprising a first set of one or more first part composites and a second set of one or more second part composites. Example 53 can include, using an automated sorting device, and identifying a first characteristic of the one or more first part composites. Example 53 can include using information about the identified first characteristic to direct the one or more first part composites to a selected one of the first and second receiving areas, and directing the one or more second part composites to the other one of the first and second receiving areas.

Example 54 can include, or can optionally be combined with the subject matter of Example 53, to optionally include using the automated sorting device, including identifying a different second characteristic of the one or more second part composites and, using information about the identified different second characteristic, directing the one or more second part composites to the other of the first and second receiving areas.

Example 55 can include, or can optionally be combined with the subject matter of one or any combination of Examples 53 or 54 to optionally include identifying the first characteristic of the one or more first part composites, including identifying a first visual characteristic of the one or more first part composites using a machine vision device. In Example 55, directing the one or more first part composites can include using information about the identified first visual characteristic.

Example 56 can include, or can optionally be combined with the subject matter of one or any combination of Examples 53 through 55 to optionally include receiving information from a CAD model about a characteristic of at least one of the first or second sets of part composites, and identifying the first characteristic of the one or more first part composites using the received information from the CAD model.

Example 57 can include, or can optionally be combined with the subject matter of one or any combination of Examples 53 through 56 to optionally include operating a robotic arm to move the one or more first part composites to the selected one of the first and second receiving areas.

Example 58 can include, or can optionally be combined with the subject matter of one or any combination of Examples 53 through 57 to optionally include operating at least one of a vacuum device or a suction device configured to move the one or more first part composites to the selected one of the first and second receiving areas.

Example 59 can include, or can optionally be combined with the subject matter of one or any combination of Examples 1 through 58 to include, subject matter (such as an apparatus, a method, a means for performing acts, or a machine readable medium including instructions that, when performed by the machine, that can cause the machine to perform acts), such as can include a drying station for use in an automated additive manufacturing system. In Example 59, the drying station can include a drying area in an additive manufacturing system, the drying area configured to receive a part composite from one of a manufacturing area or a post-processing area in the additive manufacturing system, the part composite manufactured using an additive process, and the part composite further processed using a liquid in one of a cleaning, rinsing, or curing process. Example 59 can include a drying device that is configured to provide one of a positive airflow or a negative airflow in the direction of the part composite in the drying area.

Example 60 can include, or can optionally be combined with the subject matter of Example 59, to optionally include a movable conveyor in the drying area, the movable conveyor configured to transport the part composite into or through the drying area.

Example 61 can include, or can optionally be combined with the subject matter of one or any combination of Examples 59 or 60 to optionally include a scale, including a portion of the drying area that receives the part composite, and a processor circuit communicatively coupled to the drying device and the scale. The scale can be configured to provide information about a weight of the part composite to the processor circuit, and the processor circuit can be configured to update one or more operating characteristics of the drying device in response to the part composite weight information.

Example 62 can include, or can optionally be combined with the subject matter of Example 61, to optionally include the processor circuit configured to update one or more of a fan speed, a heating status, or a cooling status of the drying device in response to the part composite weight information.

Example 63 can include, or can optionally be combined with the subject matter of one or any combination of Examples 59 through 62 to optionally include a multiple-speed fan that is adjustable based on instructions from a processor circuit.

Example 64 can include, or can optionally be combined with the subject matter of one or any combination of Examples 59 through 63 to optionally include a heater that is adjustable based on instructions from a processor circuit.

Example 65 can include, or can optionally be combined with the subject matter of one or any combination of Examples 59 through 64 to optionally include the drying device configured to provide a desiccant airflow.

Example 66 can include, or can optionally be combined with the subject matter of one or any combination of Examples 1 through 65 to include, subject matter (such as an apparatus, a method, a means for performing acts, or a machine readable medium including instructions that, when performed by the machine, that can cause the machine to perform acts), such as can include a method including, in a drying area in an additive manufacturing system, receiving a part composite from one of a manufacturing area or a post-processing area in the additive manufacturing system, the part composite manufactured using an additive process, and the part composite processed using a liquid in one of a cleaning, rinsing, or curing process, and using a drying device, providing one of a positive airflow or a negative airflow in the direction of the part composite in the drying area.

Example 67 can include, or can optionally be combined with the subject matter of Example 66, to optionally include measuring a weight of the part composite after the drying device provides the airflow for a first specified duration and, when the measured weight of the part is less than or equal to a specified weight, providing an indication that the part composite is dry or is ready for further processing.

Example 68 can include, or can optionally be combined with the subject matter of Example 67, to optionally include retrieving the specified weight from a CAD model corresponding to the part composite.

Example 69 can include, or can optionally be combined with the subject matter of one or any combination of Examples 67 or 68 to optionally include updating one of an airflow rate or an airflow temperature using information about the measured weight of the part composite.

Each of these non-limiting examples can stand on its own, or can be combined in various permutations or combinations with one or more of the other examples.

All cited patents, patent applications, and other references are incorporated herein by reference in their entirety. In the event of inconsistent usages between this document and any documents so incorporated by reference, the usage in this document controls.

Method examples described herein can be machine or computer-implemented at least in part. For example, the control circuit 150, or some other controller or processor circuit, can be used to implement at least a portion of one or more of the methods discussed herein. Some examples can include a tangible, computer-readable medium or machine-readable medium encoded with instructions that are operable to configure an electronic device to perform methods as described in the above examples. An implementation of such methods can include code, such as microcode, assembly language code, a higher-level language code, or the like. Such code can include computer-readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An automated additive manufacturing system comprising:
build sheet configured to receive extruded material from a material extrusion nozzle in a build area; and
a part removal device configured to contact the conveyable build sheet, near a location where the received extruded material contacts the build sheet, to separate a portion of the received extruded material from the conveyable build sheet;
wherein at least one of
the build sheet is a conveyable build sheet, and wherein the conveyable build sheet is movable between the build area and a post-processing area of the system; and
the part removal device that is movable between the build area and the storage area, wherein the part removal device is further movable in the build area.

2. (canceled)

3. (canceled)

4. The automated additive manufacturing system of claim 1, wherein the conveyable build sheet includes a flexible substrate, and wherein the part removal device includes a substantially planar edge configured to impinge on the flexible substrate near the location where the received extruded material contacts the build sheet.

5. The automated additive manufacturing system of claim 1, wherein the part removal device includes multiple tapered fingers that are spaced apart, wherein a narrow side of each of the tapered fingers is configured to impinge on the conveyable build sheet.

6. The automated additive manufacturing system of claim 1, wherein the conveyable build sheet includes a top, build-side surface and an opposite bottom side surface, and wherein the part removal device is configured to impinge on the bottom side surface of the conveyable build sheet near a location where the received extruded material contacts the build sheet.

7. The automated additive manufacturing system of claim 1, wherein the part removal device includes a tapered knife-end edge configured to impinge on the conveyable build sheet.

8. The automated additive manufacturing system of claim 1, comprising a conveyor adjacent to the conveyable build sheet in the post-processing area of the system, the conveyor configured to receive, from the conveyable build sheet, the extruded material after the material is separated from the build sheet.

9. The automated additive manufacturing system of claim 8, wherein the part removal device is positioned at a junction between an end edge of the conveyable build sheet and an adjacent end edge of the conveyor.

10. The automated additive manufacturing system of claim 1, wherein the conveyable build sheet comprises a portion of a conveyor belt.

11. The automated additive manufacturing system of claim 1, wherein the part removal device is configured to oscillate or vibrate.

12. The automated additive manufacturing system of claim 1, wherein
the part removal device that is movable between the build area and the storage area, wherein the part removal device is further movable in the build area.

13. A method for separating an extruded material from a build sheet in the automated additive manufacturing system of claim 1, the method comprising:
conveying a build sheet from a build area of an additive manufacturing system to a post-processing area of the additive manufacturing system, the build sheet including a surface having an extruded material deposited thereon from a material extrusion nozzle; and
separating the extruded material from the build sheet surface as the build sheet is conveyed from the build area to the post-processing area of the system, the separating including using a part removal device contact the build sheet near a location where the received extruded material contacts the build sheet.

14. The method of claim 13, wherein the separating the extruded material from the build sheet using the part removal device includes oscillating or vibrating the part removal device.

15. The method of claim 13, wherein the separating the extruded material from the build sheet using the part removal device includes using a substantially planar edge of the part removal device.

16. The automated additive manufacturing system of claim 1, wherein the build sheet is a conveyable build sheet, and wherein the conveyable build sheet is movable between the build area and a post-processing area of the system.

17. The automated additive manufacturing system of claim 1, further comprising a roller atop of which the conveyable build sheet is configured to move, wherein the conveyable build sheet is sloped on at least one side of the roller.

18. The automated additive manufacturing system of claim 1, further comprising a roller, a plate, knife, or bar configured to provide a detent or recessed portion in the conveyable build sheet.
